(19) United States
(12) Patent Application Publication
(10) Pub. No.: US 2009/0327460 A1
(43) Pub. Date: Dec. 31, 2009

(54) Application Request Routing and Load Balancing

(75) Inventors: Won Suk Yoo, Redmond, WA (US); Anil K. Ruia, Issaquah, WA (US); Michael E. Brown, Issaquah, WA (US); William J. Staples, Duvall, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/163,941

(22) Filed: Jun. 27, 2008

(51) Int. Cl. G06F 15/173; G06F 15/177

(52) U.S. Cl. 709/221; 709/226

(57) ABSTRACT

An application request router that routes incoming application message to various servers in a network farm, even though the original network request itself does not directly specify which server is to handle the request. The application request routing module uses intra-farm routing policy and characteristics of the request itself to identify which of the servers is to handle the message and then dispatches the message to the appropriate server. This allows a user to reconfigure the network farm by reconfiguring the capabilities of the servers in the network farm, and then altering the routing policy accordingly to take advantage of the reconfigured network farm capabilities.

### BACKGROUND

In the Open Systems Interconnection (OSI) Reference Model (referred to often as the OSI model), application level messages are used to communicate information from one application level component to another using various lower level protocol levels. Examples of application level requests include HyperText Transport Protocol (HTTP) requests and responses used for many Web access, Internal Message Application Protocol (IMAP) and Post Office Protocol (POP) used for e-mail, File Transfer Protocol (FTP) for downloading of files, and so forth. There are dozens, perhaps hundreds of application level protocols, each having one or more versions, and each having correspondingly structured application level messages.

Even in any given protocol, the application level messages have different characteristics that often have implications as the type and amount of resources consumed in processing the message upon receipt. For instance, while there are many application level protocols, the HTTP protocol will be discussed as an example in which the message is an HTTP request used for accessing web pages.

For instance, an HTTP request may require different amounts and types of processing, bandwidth, and memory allocation depending on the type of requested content. As an example, the providing of a video in response to a request will require much more bandwidth and storage at the server than would the providing of an image, or a text or HyperText Markup Language (HTML) document. In addition, different HTTP requests might have different connection characteristics, some being shorted lived and some being long lived.

Because of these differences, when all types of HTTP requests are serviced by one server, it is difficult, if not impossible, to differentiate the server utilization based on the types. Accordingly, when a server hits its capacity, it is difficult to immediately determine what kind of HTTP requests are responsible for the server saturation and therefore should be scaled. Without this understanding or visibility, an administrator may blindly choose to scale horizontally by simply adding a new server that is capable of doing the same thing that the existing overloaded server is capable of doing, and then load balancing between the two similar servers. The result is that the administrator may increase the capacity on the kinds of HTTP requests that do not need to be scaled, thereby potentially inefficiently using server resources.

### BRIEF SUMMARY

Although not required, some embodiments of the present invention relate to the use of an application request router to route incoming application messages to various specialized servers in a network farm, even though the original application message itself does not directly specify which server is to handle the request. The application request routing module uses the intra-farm routing policy and characteristics of the request itself to identify which of the servers is to handle the message and then dispatches the message to the appropriate server without making changes to the existing application.

This allows a user (most likely an administrator) to reconfigure the network farm by fine-tuning the capabilities of the servers in the network farm, and then altering the routing policy accordingly to take advantage of the reconfigured capabilities of the various servers. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a computing system in which embodiments described herein may operate;

FIG. 2 illustrates a message processing environment that represents just one of many environments in which the principles described herein may operate;

FIG. 3 illustrates a flowchart of a method for directing incoming application level network messages through a network farm;

FIG. 4 illustrates an example message flow associated with a three tier architecture wherein the configurable intra-farm routing policy specifies a routing policy on the basis of a requested file type of the application request; and

FIG. 5 illustrates a flowchart of a method for reconfiguring a network farm such as that illustrated with respect to FIGS. 2 and 4.

### DETAILED DESCRIPTION

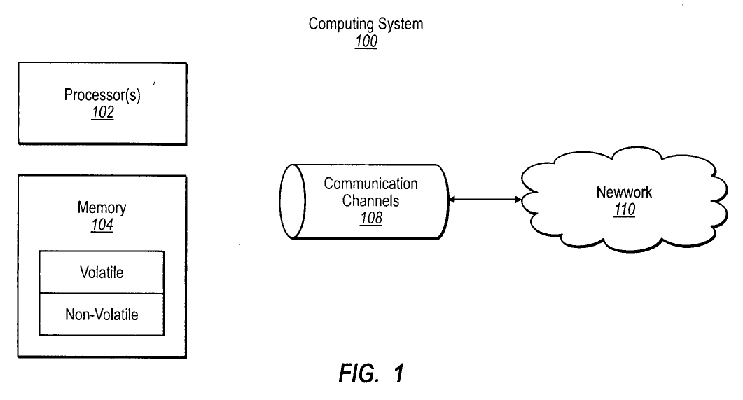

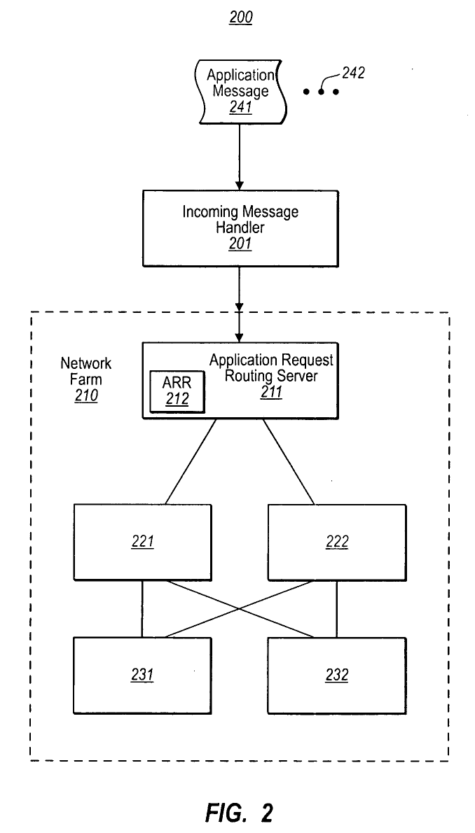

Embodiments described herein relate to an application request router that routes incoming application level network requests to various servers in a network farm, even though the original network request itself does not directly specify which server is to handle the request. After the network farm is identified for a particular application message, the application request routing module for that network farm uses the intra-farm routing policy and characteristics of the request itself to identify which of the servers of the network farm is to handle the message and then dispatches the message to the appropriate server. First, some introductory discussion regarding a computing system in which the principles described herein may be employed will be described with respect to FIG. 1. Then, the basic principles of the application request router and examples uses will be described with respect to FIGS. 2 through 5.

FIG. 1 illustrates a computing system 100. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term “computer-readable media” as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates a message processing environment 200 that represents just one of many environments in which the principles described herein may operate. The environment 200 potentially includes an incoming message handler 201 that receives application messages 241 and 242. The application message is an application level message that may be sent and interpreted at the application level in the protocol stack. Only one application message 221 is illustrated. However, the horizontal ellipses 242 represents that the incoming message handler 201 may handle more application level messages. In fact, the incoming message handler 201 may handle an enormous number of application messages perhaps on a continuing basis. Herein, the terms “application message” and “application level message” may be used interchangeably”. In some cases the application message will have been transmitted over a network, although that is not necessary.

The incoming message handler 201 may be any module or combination of modules that applies logic to determine the destination of the application message. One possible destination is the network farm 210, which is the only relevant destination for purposes of this description. Accordingly, the other possible destinations are not illustrated. In this case, the network farm 210 includes multiple physical servers that operate in a common sphere of trust and collaborate to offer an integrated service. The network farm 210 may perhaps be identified under a single identifier such as, for example, a web farm alias.

One of the possible advantages of this application request routing server 211 is that the network farm 210 may have any one of a practically enumerable variety of configurations. The application messages may be appropriately routed in any of those configurations by properly configuring the routing policy associated with that network farm (i.e., the “intra-farm routing policy”) accordingly. However, for purposes of illustration only, the network farm 210 is illustrated as being in a three-tier architecture, with the application request routing server 211 in tier one, with two servers 221 and 222 in tier two, and with two servers 231 and 232 in tier three. As an example only, the servers 221 and 222 might be, for example, content servers, and servers 231 and 232 might be, for example, database servers accessible to the content servers. Although the application request routing server 211 is illustrated as including the application request router 212, that is not required. The application request router 212 may be external to the network farm 210 and/or server to designate routing for multiple network farms.

The incoming message handler 201 and the application request routing module 212 may each be application level modules that may be located on the same physical machine, or on different physical machines. In one embodiment, they are part of an application level pipeline that multiple application level modules may register with. Accordingly, the application request routing module 212 may integrate seamlessly with other application level functions such as, for example, caching. An example of such an extensible and integrated pipeline is provided by Internet Information Services (IIS) Server.

The incoming message handler may be any module, and the type of incoming message handler is extensible so long as the incoming message handler identifies the network farm to the application request routing server. Examples of an incoming message handler may be, for example, a Uniform Resource Locator (URL) rewrite module, a mail server, or perhaps a SHAREPOINT® module. Having said that, in some embodiments, the incoming message handler 201 is optional as will be described further below.

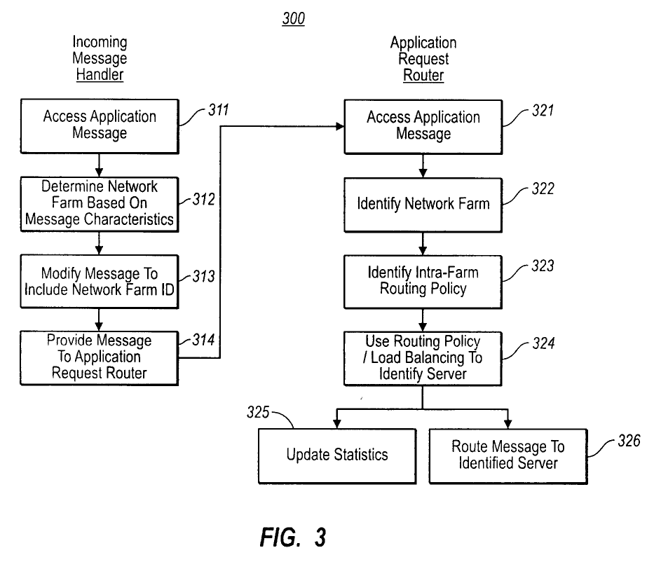

FIG. 3 illustrates a flowchart of a method 300 for directing incoming application level network messages through a network farm. Some of the acts of the method 300 may be performed by the incoming message handler 201 as represented in the left column of FIG. 3 under the heading “Incoming Message Handler”. Others of the acts of the method 300 may be performed by the application request routing module 211 as represented in the right column of FIG. 3 under the heading “Application Request Router”.

The incoming message handler accesses a network message (act 311). For instance, in FIG. 2, the incoming message handler 201 accesses the application level message 241.

The incoming message handler may determine external routing policy associate with the application message sufficient to identify a network farm that the application message is to be routed to (act 312). That external routing policy may be configurable, and though the actual routing may depend on some characteristics in the application message itself, the routing is not at least initially specified in the application message. For instance, the incoming message handler 201 may identify that the application message 241 is to be routed to the network farm 210.

In addition, the incoming message handler 201 may also modify the application message to designate the network farm the application message is to be sent to (act 313). The application message is then provided to the application request routing module corresponding to that network farm (act 314). For instance, this may be done with the assistance of an application level pipeline such as, for example, IIS.

The application request routing module then accesses the application message (or at least a modified version of the application message) from the incoming message handler (act 321). For instance, in FIG. 2, the application message 221 may be received by the application request routing server 211 from the incoming message handler 201.

The application request routing module then identifies the network farm associated with the message (act 322). This might be done by, for example, inspecting the network farm identifier that was added by the incoming message handler. The application request router identifies the routing policy for the network farm (323). If the application request router serves but a single network farm, as might be the case if the application request router resides in the network farm, there might be only a single set of intra-farm routing policies that is used by the application request router. On the other hand, if there are multiple network farms served by the application request router, the application request router would access the intra-farm routing policy corresponding to the network farm.

The application request router may also determine one or more characteristics of the application message since the policy for determining which server in the network farm is to handle the application message (i.e., the intra-farm routing policy) might be dependent on certain characteristics of the application message. The precise characteristic types needed will depend on the specific intra-farm routing policy. One type of routing policy might depend on the file type of the target file that is the object of the application message. Another type of routing policy might depend on the anticipated processing time associated with processing the message, and so forth.

The application request routing module may optionally statistically track the characteristics of incoming messages. Accordingly, when a message having particular characteristics is received, the routing module may update that statistical information (act 325). This statistical information may assist a network administrator of the network farm 210 in determining not only whether one or more servers of the network farm are reaching capacity, but also what types of application messages are causing the greatest contribution.

For instance, suppose video file requests are saturating network bandwidth or are saturating processing capabilities of various servers. The administrator may view the statistical information to determine that this is the case. Accordingly, instead of scaling horizontally, the administrator may decide that one of the servers needs to be reconfigured to only handle requests for video files. That server may thus become specialized, thereby reducing the variety of application messages that the remaining servers have to deal with. This specialization can allow for more efficient use of processing and bandwidth as compared to the alternative of horizontal scaling.

However, the configurable intra-farm routing policy was obtained, that policy may then be used to identify which of the servers in the network farm will handle the request (act 324). That intra-farm routing policy may also depend on the current state of the network farm. The application request router 212 may then forward the application message to the identified server (act 326). For instance, the application request router 212 may then forward the application message 241 to either the server 221 or the other server 222 in accordance with the intra-farm routing policy corresponding to the network farm 210. If there are multiple possibilities for which server the request may be routed to, the incoming message handler 201 may also perform load balancing. For instance, the routing policy may also incorporate load balancing by routing to the lesser-utilized servers. Other farm state that might be relevant for the intra-farm routing policy might include which servers are operating properly and which are not.

The application message is then dispatched accordingly to the routing policy (act 326).

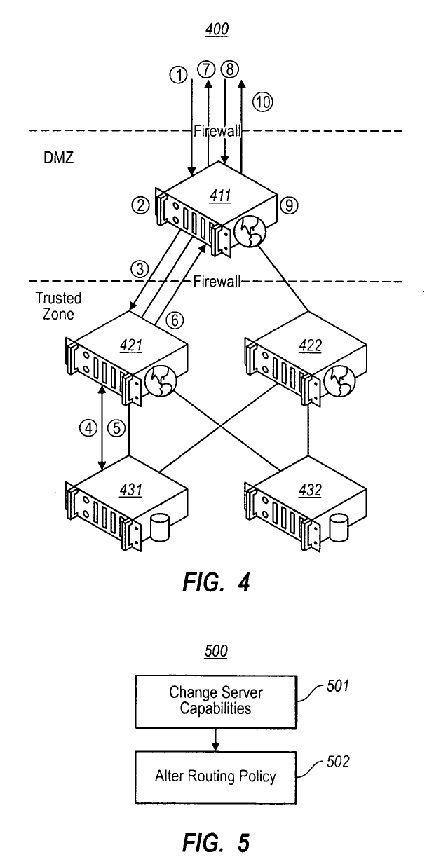

FIG. 4 illustrates an example message flow 400 associated with a three tier architecture wherein the configurable intra-farm routing policy specifies a routing policy on the basis of a requested file type of the application request. In this very specific example, the application request may be an HTTP request, which has an associated target file type. Some file types (such as ASPX file types) suggest dynamic content, while others (such as image file types an example being JPG) suggest static content.

In step 1, a client requests a dynamic content file called “index.aspx”. In step 2, the tier one server 411 (which includes the application request routing module and the incoming message handler) determines that the requested target file is an “.aspx” file, and checks the associated external routing rule for that file type. In one embodiment, this is performed by the incoming message handler. In this case, suppose the routing rule specifies that the left tier 2 server 421 is to specifically handle requests for .aspx files. Alternatively, perhaps the routing rule specifies that either of the tier 2 servers 421 and 422 will suffice, by the tier one server 411 performs load balancing to identify server 421 as the server that is to handle the message.

In either case, in step 3, the request for the .aspx file is forwarded to the tier two server 421. The aspx file is then executed using the appropriate inputs provided in the application message. As part of this execution, the tier two server 421 may access either of the tier three database servers 431 or 432 to acquire information. In this specific example, steps 4 and 5 show data access to the tier three database server 431.

The response generated by execution of the .aspx file is then returned to the tier one server 411 as represented by step 6. The tier one server 411 then sends the response back to the client as represented by step 7.

The client then sends a request for a “.jpg” file to the tier one server 411 as represented by step 8. At this point, it is noted that in an ordinary web page request, the client browser often will make a number of requests for content as content references are found in the web page. For instance, if the initial web page request might be for a .aspx file that generates the framework for the web page, while various pictures, videos, banners and the like might be referred to in that framework, and acquired through separate requests.

In step 9, the tier one server 411 checks the routing rules for .jpg files and determines that the tier one server 411 itself can satisfy the request. Accordingly, the request is handled by the tier one server 411 and an appropriate response is sent to the client as represented by step 10.

In this example, the configurable external routing policy specifies routing according to file type. As a related example, the configurable routing policy may specify routing according to whether the request is for dynamic content, or static content. This is related to the file type example since the dynamic and static nature of the requested content may often be determined by the file type. For instance, in the example of FIG. 4, the tier one server 411 may handle static content, while the tier two servers 421 and 422 handle dynamic content. Alternatively, perhaps the tier one server 411 handles only simple static content (such as relatively small image files), while the tier two server 422 handles more resource intensive static content (such as video files), while the tier two server 421 handles dynamic content.

The configurable routing rules might also specify a routing policy according to expected execution time for responding to the application requests. For instance, in Web Services, a presentation request may have a short execution time, whereas other processing requests may have longer execution times. Accordingly, in FIG. 4, perhaps one of the servers (server 411) handles requests involving the short-running execution times, whereas the tier two servers (server 421 and/or 422) handle requests involving the long-running execution times.

The ability to configure the tier one server allows for convenient redirection of routing policy in accordance with a reconfiguration or readjustment of the work assignments of various servers in the network farm. FIG. 5 illustrates a flowchart of a method for reconfiguring a network farm such as that illustrated with respect to FIGS. 2 and 4.

First, the capabilities of at least one of the servers in the network farm are changed (act 501) such that there is a change in the types of application level requests that may be handled by the corresponding reconfigured server(s). Once that happens, the administrator may simply alter the configurable routing policy such that appropriate application level messages are provided to the reconfigured server(s) in consideration of its or their reconfigured capabilities (act 502).

In the first example where different servers are to be assigned dynamic content requests, and other different servers are to be assigned static content requests, the administrator may simply alter the configurable routing policy such that application requests for dynamic content are handled by one of the set of at least one other server(s), and such that the application requests for static content are handled by the application routing server.

In the second example where different servers are assigned for shorter running and longer running execution times, the administrator may simply alter the configurable routing policy such that the relatively longer running application requests are handled by one of the set of at least one other server(s), and such that the application requests for the relatively shorter running application requests are handled by another subset of the servers.

Accordingly, embodiments have been described in which an application routing module may route application level network requests within a network farm. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. A computer program product comprising one or more computer-readable media having thereon one or more computer-executable instructions that, when executed by one or more processors of a computing system, cause the computing system to perform a method for directing application messages through a network farm comprising a plurality of servers, the method comprising:
an act of accessing an application message from an incoming message handler;
an act of using configurable intra-farm routing policy to identify which of the plurality of servers in the network farm will handle the application message; and
an act of dispatching the application message to the identified server that will handle the application message.

2. A computer program product in accordance with claim 1, wherein the one or more computer-readable media is physical memory and/or storage media.

3. A computer program product in accordance with claim 2, wherein the incoming message handler identifies the network farm that is to process the application message.

4. A computer program product in accordance with claim 3, wherein the incoming message handler also modifies the application message to identify the network farm.

5. A computer program product in accordance with claim 4, wherein the configurable intra-farm routing policy is not specified in the application message at least prior to being handled by the incoming message handler.

6. A computer program product in accordance with claim 4, wherein the incoming message handler is a Uniform Resource Locator (URL) rewrite module.

7. A computer program product in accordance with claim 3, wherein the incoming message handler is a mail server.

8. A computer program product in accordance with claim 3, wherein the configurable intra-farm routing policy specifies a routing policy on the basis of a requested file type of the application message.

9. A computer program product in accordance with claim 3, wherein the incoming message handler determines the network on the basis of whether the application message is for dynamic content or static content.

10. A computer program product in accordance with claim 3, wherein the computing system is part of the network farm.

11. A computer program product in accordance with claim 3, wherein the configurable intra-farm routing policy specifies a routing policy accordance to an expected execution time for responding to the application messages, wherein relatively longer running network requests are directed towards a server in a first set of one or more servers of the plurality of servers, and application messages that are relatively shorter running are directed towards a server in a second set of one or more servers.

12. A computer program product in accordance with claim 2, wherein the one or more computer-executable instructions are further structured such that, when executed by the one or more processors of the computing system, the method comprises:
an act of updating statistical information to reflect the network farm processing the application message, the statistical information tracking one or more characteristics for a plurality of received application messages.

13. A computer program product in accordance with claim 2, wherein the application message is an application level network request.

14. A computer program product in accordance with claim 13, wherein the application level network request is a HyperText Transport Protocol (HTTP) request.

15. A computer program product in accordance with claim 14, wherein the application message is a first HTTP request, wherein the one or more computer-executable instructions are further structured such that, when executed by the one or more processors of the computing system, when a second HTTP request is accessed, the configurable intra-farm routing policy may be used to identify a different server in the network farm to handle the second HTTP request as compared to the server in the network farm that handled the first HTTP request, even though the first and the second HTTP requests are associated with the same Web page, and even though the original first and second HTTP requests did not specify which physical server is to handle the HTTP request.

16. A method for reconfiguring a network farm that includes a plurality of servers including an application routing server and a set of at least one other server(s), wherein the application routing server is configured to use configurable intra-farm routing policy and characteristics of incoming application messages to identify which of the plurality of servers is to handle the incoming application message such that some incoming application message will be handled by one of the server(s) in the set, and other incoming messages are handled by another of the plurality of servers, the method comprises:
an act of reconfiguring capabilities of at least one of the plurality of servers such that there is a change in the types of application messages that may be handled by the corresponding reconfigured server(s); and
an act of altering the configurable routing policy such that appropriate an application messages are provided to the reconfigured server(s) in consideration of its or their reconfigured capabilities.

17. A method in accordance with claim 16, wherein the act of configuring comprises altering one of the plurality of servers so that it handles requests for content of a particular type, and another so that they handle requests for content of another.

18. A method in accordance with claim 16, wherein the act of configuring comprises altering the intra-farm routing policy such that one of the plurality of servers handles relatively long running application messages, and another handles relatively short running application messages.

19. A computer program product comprising one or more computer-readable media having thereon one or more computer-executable instructions that, when executed by one or more processors of a computing system, cause the computing system to perform a method for directing application messages through a network farm comprising a plurality of servers, the method comprising:
an act of accessing a plurality of application messages;
for each of at least some of the plurality of application level network requests, performing the following:
an act of identifying a file type for a requested resource of the corresponding application message;
an act of using configurable intra-farm routing policy and the identity of the file type to identify which of the plurality of servers in the network farm will handle the application message even though the application message did not specify which server in the network farm would handle the application message at least prior to being handled by an incoming message handler; and
an act of dispatching the application message to the identified server that will handle the request.

20. A computer program product in accordance with claim 19, wherein the one or more computer-readable media is physical memory and/or storage media.
